(19) United States
(12) Patent Application Publication
(10) Pub. No.: US 2014/0085703 A1
(43) Pub. Date: Mar. 27, 2014

(54) PIXEL STRUCTURE

(71) Applicant: AU OPTRONICS CORP., Hsin-Chu (TW)

(72) Inventors: Hung-Yi Chen, Hsin-Chu (TW); Chien-Kai Chen, Hsin-Chu (TW); Chen-Hsien Liao, Hsin-Chu (TW)

(73) Assignee: AU OPTRONICS CORP., Hsin-Chu (TW)

(21) Appl. No.: 13/844,361

(22) Filed: Mar. 15, 2013

(30) Foreign Application Priority Data
Sep. 26, 2012 (TW) 101135432

(51) Int. Cl. G02B 26/00

(52) U.S. Cl. CPC G02B 26/005
USPC 359/290

(57) ABSTRACT

A pixel structure is provided, which includes a first substrate, a second substrate, a plurality of ribs, a plurality of first pixel electrodes, a plurality of second pixel electrodes, a color display medium, a black display medium, a light transmissive medium and a color filter. The ribs are formed between the first and second substrates. The first and second pixel electrodes are formed between the first substrate and the second substrate. The color display medium and the black display medium are formed on the first and second substrates respectively. The light transmissive medium is formed between the first and second substrates. The color filter is formed on the first substrate or on the second substrate. Spectrums, which light is allowed to pass through the color filter and the color display medium in one of sub pixel zones which the ribs divide the pixel structure into, overlap each other partially.

### CROSS-REFERENCE TO RELATED APPLICATIONS

This non-provisional application claims priority under 35 U.S.C. §119(a) on Patent Application No(s). 101135432 filed in Taiwan, R.O.C. on Sep. 26, 2012, the entire contents of which are hereby incorporated by reference.

### TECHNICAL FIELD

The disclosure relates to a pixel structure, and more particularly to a pixel structure using an electro-wetting theory.

### BACKGROUND

For the conventional display technique of electronic paper, the small ball with charges is disposed between two substrates. One surface of the small ball is white, and another surface of the small ball is black. When the substrates are applied with a voltage to form an electrical field therebetween, the small ball may rotate and then show the target color (black or white) thereof to user. That is why the conventional electronic paper is capable of displaying frames with black and white. Another display technique of electronic paper which uses the microcapsule instead of the conventional small ball was created afterward by Joseph Jacobson in the 1990s. The microcapsule is filled with color oil and with white particles containing charges. When the microcapsule is applied with a voltage to form an electrical field within, the white surface thereof or the surface with the color of the color oil thereof may face the user so as to form a color by mixing various colors generated by the color oil. However, such a manner is not capable to form black. This may cause the electronic paper to not display abundant colors.

Thus, it is important in the art to develop an electronic paper or other display devices which are capable of displaying abundant colors.

### SUMMARY

According to an embodiment of the disclosure, a pixel structure comprises a first substrate, a second substrate, a plurality of ribs, a plurality of first pixel electrodes, a plurality of second pixel electrodes, a color display medium, a black display medium, a light transmissive medium and a color filter. The first substrate is opposite to the second substrate. The ribs are formed between the first substrate and the second substrate and divide the pixel structure into a plurality of sub pixel zones. The first pixel electrodes are formed on the first substrate and respectively in the sub pixel zones. The second pixel electrodes are formed on the second substrate and respectively in the sub pixel zones. The color display medium is formed on the first substrate and among the ribs. The color display medium comprises a red droplet, a green droplet and a blue droplet. The red droplet, the green droplet and the blue droplet are formed in the sub pixel zones respectively. The black display medium is formed on the second substrate and among the ribs. The light transmissive medium is formed between the first substrate and the second substrate. The color filter is formed on the first substrate or on the second substrate and comprises a magenta section, a yellow section and a cyan section. Spectrums, which light is allowed to pass through the color filter and the color display medium in one sub pixel zone, overlap each other partially.

According to an embodiment of the disclosure, a pixel structure comprises a first substrate, a second substrate, a plurality of ribs, a plurality of first pixel electrodes, a first color display medium and a light transmissive medium. The first substrate is opposite to the second substrate. The ribs are disposed between the first substrate and the second substrate and divide the pixel structure into a plurality of sub pixel zones. The first pixel electrodes are disposed on the first substrate and are respectively in the sub pixel zones. Each sub pixel zone comprises an electrodeless section between the first pixel electrode and the rib. The first color display medium is disposed on the first substrate and is among the ribs. The light transmissive medium is disposed between the first substrate and the second substrate.

For purposes of summarizing, some aspects, advantages and features of some embodiments of the disclosure have been described in this summary. Not necessarily all of (or any of) these summarized aspects, advantages or features will be embodied in any particular embodiment of the disclosure. Some of these summarized aspects, advantages and features and other aspects, advantages and features may become more fully apparent from the following detailed description and the appended claims.

### BRIEF DESCRIPTION OF THE DRAWINGS

The present disclosure will become more fully understood from the detailed description given herein below for illustration only, and thus does not limit the present disclosure, wherein:

FIG. 1A is a sectional diagram of a pixel structure according to an embodiment of the disclosure;

FIG. 1B is a sectional diagram of the pixel structure of FIG. 1A applied with a bias voltage;

FIG. 2A is a sectional diagram of a pixel structure according to an embodiment of the disclosure;

FIG. 2B is a sectional diagram of the pixel structure of FIG. 2A displaying magenta;

FIG. 2C is a sectional diagram of the pixel structure of FIG. 2A displaying red;

FIG. 2D is a sectional diagram of the pixel structure of FIG. 2A displaying a color between magenta and blue;

FIG. 2E is a comparison diagram of CIE xy chromaticity diagrams of the pixel structure of FIG. 2A and a conventional pixel structure;

FIG. 3 is a sectional diagram of a pixel structure according to an embodiment of the disclosure;

FIG. 4 is a sectional diagram of a pixel structure according to an embodiment of the disclosure; and

FIG. 5 is a sectional diagram of a pixel structure according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

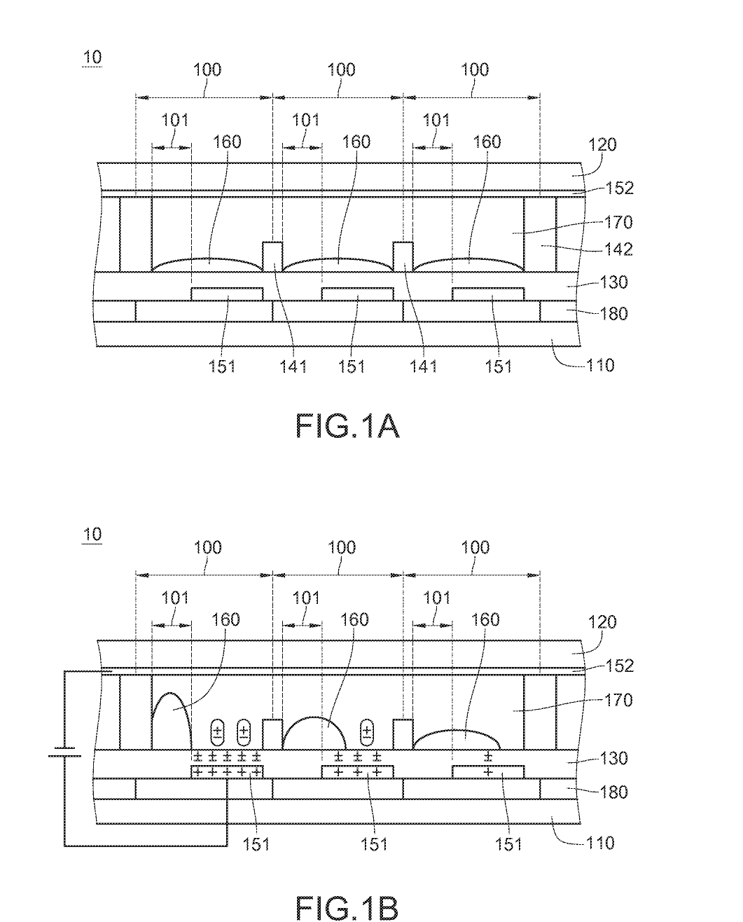

Referring to FIG. 1A and FIG. 1B, a pixel structure 10 includes a first substrate 110, a second substrate 120, a plurality of ribs 141, a plurality of ribs 142, a plurality of pixel electrodes 151, a common electrode 152, a plurality of color display mediums 160, a light transmissive medium 170 and a color filter 180.

The first substrate 110 is opposite to the second substrate 120. A film layer 130 is formed on the first substrate 110. The film layer 130 is opposite to the second substrate 120. The ribs 141 and 142 are formed between the film layer 130 and the second substrate 120. The ribs 141 are formed on the film layer 130. The ribs 142 are formed between, and contact the film layer 130 and the common electrode 152. The ribs 141 and 142 divide the pixel structure 10 into a plurality of sub pixel zones 100.

The pixel electrodes 151 are between the first substrate 110 and the film layer 130 and are respectively in the sub pixel zones 100. Each of the sub pixel zones 100 includes an electrodeless section 101. Each of the pixel electrodes 151 is in the corresponding sub pixel zone 100. The pixel electrodes 151 are formed between the film layer 130 and the color filter 180, and the color filter 180 is formed on the first substrate 110. In some an embodiments, the color filter 180 is formed on the second substrate 120, or is between the common electrode 152 and the second substrate 120, or is eliminated. In the embodiment, the pixel electrodes 151 are formed between the color filter 180 and the first substrate 110.

The electrodeless section 101 is between the pixel electrode 151 and the rib 141 or between the pixel electrode 151 and the rib 142. The color display medium 160 is formed on the film layer 130 and is also among the ribs 141 and 142. The light transmissive medium 170 is formed between the film layer 130 and the second substrate 120. The common electrodes 152 are formed on the light transmissive medium 170.

In this embodiment, the forgoing structure allows light to project on the pixel structure 10 from the first substrate 110 or from the second substrate 120, so that the pixel structure can be applied in a smart window. In some embodiments, a reflective backplate is formed on the first substrate 110 or on the second substrate 120, so that the pixel structure can be applied in a reflective display device. In some embodiments, a backlight module is formed on the first substrate 110 or on the second substrate 120, so that the pixel structure can be implemented in a LED display device.

The first substrate 110 and the second substrate 120 are flexible substrates, glass substrates or active matrix substrates. The light transmissive medium 170 and the ribs 141 and 142 are made of polar material. The film layer 130 and the color display medium 160 are made of non-polar material and are hydrophobic. The color display medium 160 is, for example, color oil or black oil. When the color display medium 160 is black oil, each of the sub pixel zones 100 displays a color formed by light passing through a corresponding location in the color filter 180. When the color display medium 160 is color oil, each of the sub pixel zones 100 displays a color formed by mixing the colors which light passes through the color display medium 160 and the color filter 180 respectively.

As shown in FIG. 1A, when the pixel structure 10 is not applied with a voltage, the hydrophobic color display medium 160 may spread on the hydrophobic film layer 130. Herein, when light projects on the pixel structure 10 from the first substrate 110 or from the second substrate 120, light is filtered out by the color filter 180 and is absorbed by the color display medium 160.

In the embodiment of the color display medium 160 as black oil, the color display medium 160 absorbs the entire visible light, so that light does not pass through the color display medium 160. Thus, no matter if light penetrates into the color filter 180 first, or into the color display medium 160 first, the pixel structure 10 always displays black.

In the embodiment of the color display medium 160 as color oil, the spectrums, which light is allowed to pass through the color display medium 160 and the color filter 180 in every sub pixel zone 100, do not overlap each other. Herein, the spectrum which light is allowed to pass through the color display medium 160 is the spectrum which light is absorbed by the color filter 180. The spectrum which light is allowed to pass through the color filter 180 is the spectrum which light is absorbed by the color display medium 160. Thus, the pixel structure 10 may display black.

As shown in FIG. 1B, when the common electrodes 152 are applied with a low voltage and the pixel electrodes 151 are applied with a high voltage, an electrical field between the common electrode 152 and the pixel electrodes 151 is formed. The film layer 130 made of non-polar material is getting polarized by the electrical field. Thus, the color display medium 160 made of non-polar material attaches to the film layer 130 difficultly, and the light transmissive medium 170 made of polar material moves to the position of the polarized film layer 130 and repels the color display medium 160. On the other hand, the electrodeless section 101, which is between the pixel electrode 151 and the rib 141 or between the pixel electrode 151 and the rib 142, has no electrode within, so that the film layer 130 in the electrodeless section 101 is not polarized and has no polarity. Thus, the color display medium 160 is repelled by the light transmissive medium 170 to the position of every electrodeless section 101 and agglutinates, and the partial color display medium 160 contacts with the surface of the rib 141 or of the rib 142. Herein, light in the pixel structure 10 passes through the color filter 180 to show the color formed by which light is allowed to pass through the color filter 180.

To allow more light to pass through the color filter 180, the voltage between the common electrode 152 and the pixel electrodes 151 is increased as shown in the left side of FIG. 1B. The color display medium 160 moves to and agglutinates at the positions of the electrodeless sections 101. To allow less light to pass through the color filter 180, the voltage between the common electrode 152 and the pixel electrodes 151 is reduced as shown in the right side of FIG. 1B. The color display medium 160 slightly moves to and agglutinates at the positions of the electrodeless sections 101 respectively. Thus, the gray level of each of the sub pixel zones 100 may be controlled by adjusting the light quantity of each of the sub pixel zones 100.

Moreover, the color display medium 160 moves to the position of every electrodeless section 101 non-randomly whereby the frame displayed may be more concordant. To reduce the brightness of the pixel structure 10, the voltage between the common electrode 152 and the pixel electrode 151 is reduced. The color display medium 160 attaches to the ribs 141 and 142 made of polar material difficulty whereby the color display medium 160 returns to the original positions on the film layer 130. The response time that the pixel structure 10 controls the light quantity may be reduced.

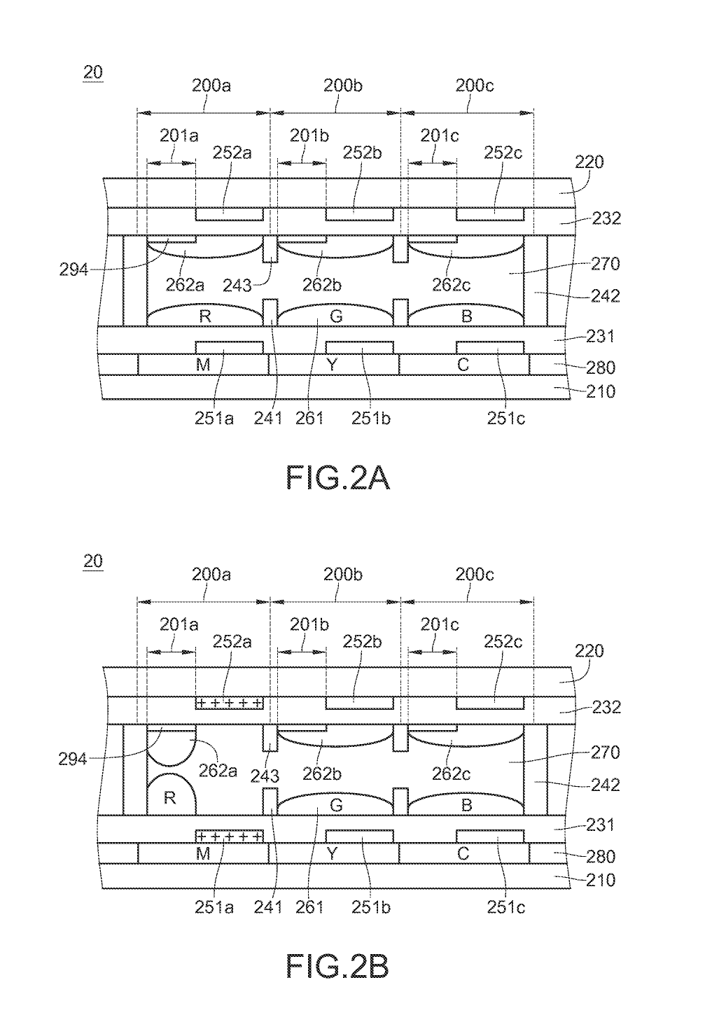

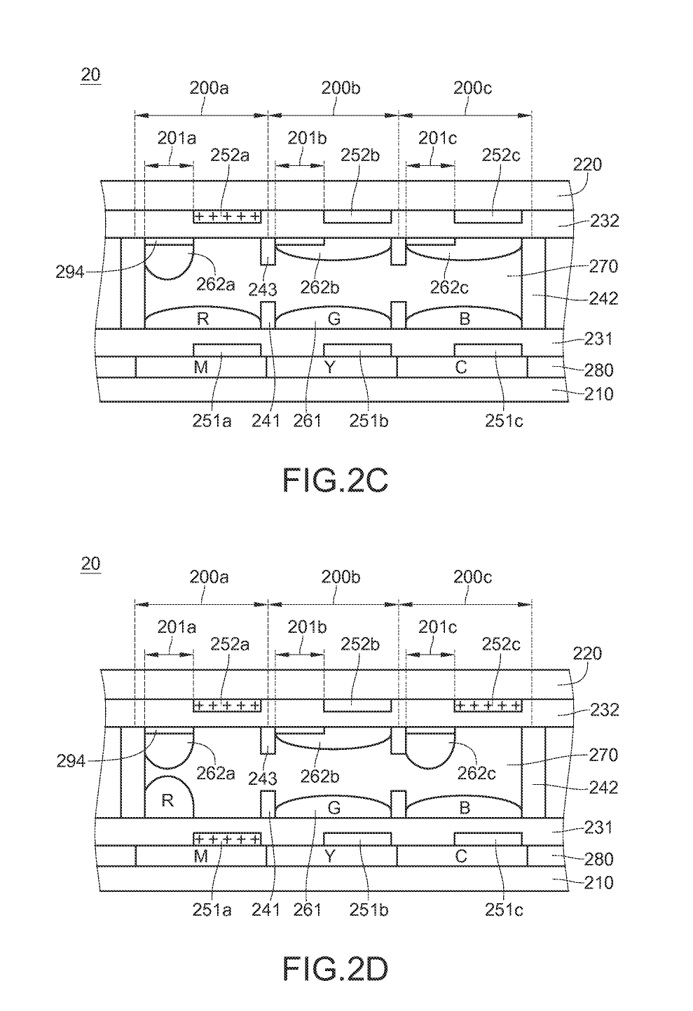

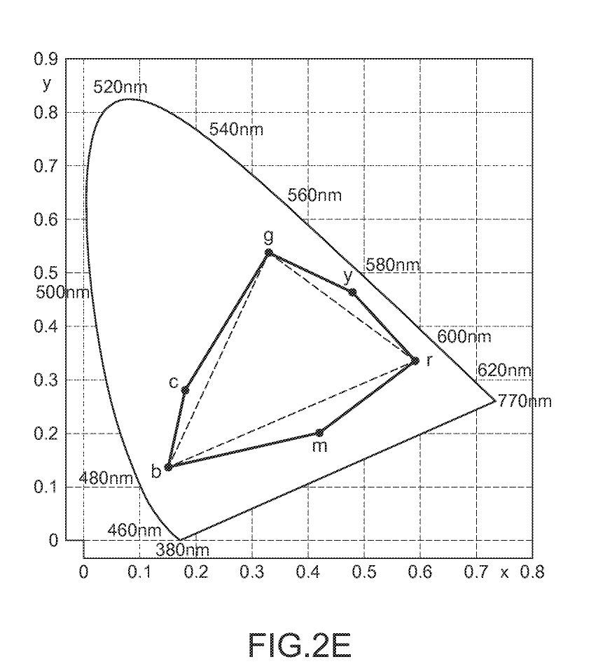

FIG. 2A illustrates a sectional diagram of the pixel structure 20 according to an embodiment of the disclosure. The pixel structure 20 includes a first substrate 210, a second substrate 220, a plurality of ribs 241, a plurality of ribs 242, a plurality of ribs 243, first pixel electrodes 251a, 251b and 251c, second pixel electrodes 252a, 252b and 252c, a color display medium 261, black display mediums 262a, 262b and 262c, a light transmissive medium 270, a color filter 280 and a black array 294.

The first substrate 210 is opposite to the second substrate 220. A first film layer 231 is formed on the first substrate 210. A second film layer 232 is formed on the second substrate 220. The first film layer 231 is opposite to the second film layer 232. The ribs 241, 242 and 243 are formed between the first film layer 231 and the second film layer 232. The ribs 241 are formed on the first film layer 231. The ribs 243 are formed on the second film layer 232. The ribs 242 are formed on and in contact with both of the first film layer 231 and the second film layer 232. The ribs 241 are opposite to the ribs 243 respectively. The ribs 241, 242 and 243 divide the pixel structure 20 into a plurality of sub pixel zones, e.g. a sub pixel zone 200a, a sub pixel zone 200b and a sub pixel zone 200c.

The first pixel electrodes 251a, 251b and 251c are between the first substrate 210 and the first film layer 231. The second pixel electrodes 252a, 252b and 252c are between the second substrate 220 and the second film layer 232. The first pixel electrode 251a and the second pixel electrode 252a are in the sub pixel zone 200a, the first pixel electrode 251b and the second pixel electrode 252b are in the sub pixel zone 200b, and the first pixel electrode 251c and the second pixel electrode 252c are in the sub pixel zone 200c.

The sub pixel zones 200a, 200b and 200c further include electrodeless sections 201a, 201b and 201c respectively. The electrodeless section 201a is between the first pixel electrode 251a and the rib 242 and is also between the second pixel electrode 252a and the rib 242. The electrodeless section 201b is between the first pixel electrode 251b and the rib 241 and is also between the second pixel electrode 252b and the rib 243. The electrodeless section 201c is between the first pixel electrode 251c and the rib 241 and is also between the second pixel electrode 252c and the rib 243.

The color display medium 261 is formed on the first film layer 231 and is also among the ribs 241 and 242. The color display medium 261 includes a red droplet R, a green droplet G and a blue droplet B. The red droplet R, the green droplet G and the blue droplet B are formed in the sub pixel zones 200a, 200b and 200c respectively. The black display mediums 262a, 262b and 262c are formed on the second film layer 232. The black display medium 262a is between the ribs 242 and 243. The black display medium 262b is between the two adjacent ribs 243. The black display medium 262c is between the ribs 242 and 243. The light transmissive medium 270 is formed between the first film layer 231 and the second film layer 232. The common electrode (not shown) may be formed on the light transmissive medium 270 to control the voltage of the light transmissive medium 270.

The color filter 280 is formed on the first substrate 210 or the second substrate 220, or between the layer of the second pixel electrodes, and the second substrate 220. The first pixel electrodes 251a, 251b and 251c are formed between the color filter 280 and the first film layer 231 or between the color filter 280 and the first substrate 210. The color filter 280 includes a magenta section M, a yellow section Y and a cyan section C. The magenta section M corresponds to the red droplet R. The yellow section Y corresponds to the green droplet G. The cyan section C corresponds to the blue droplet B.

The color filter 280 and the color display medium 261 in one sub pixel zone 200a, 200b or 200c correspond to a spectrum respectively, and two spectrums overlap each other partially. For example, magenta is formed by light except green light and thereby corresponding to the colors except green, yellow is formed by light except blue light and thereby corresponding to the colors except blue, and cyan is formed by light except red light and thereby corresponding to the colors except red.

The black array 294 is formed on the second film layer 232 and in the electrodeless sections 201a, 201b and 201c. Thus, every oil droplet moves to and agglutinates at a common position in the sub pixel zone thereof to avoid the interference among the colors displayed by the sub pixel zones 200a, 200b and 200c.

The first substrate 210 and the second substrate 220 are, for example, flexible substrates, glass substrates or active matrix substrates. The light transmissive medium 270 and the ribs 241, 242 and 243 are made of polar material. The first film layer 231, the second film layer 232, the black display mediums 262a, 262b and 262c and the color display medium 261 are made of non-polar material and are hydrophobic.

When the pixel structure 20 is not applied with a voltage, the hydrophobic color display medium 261 spreads on the hydrophobic first film layer 231. The hydrophobic black display mediums 262a, 262b and 262c spread on the second film layer 232 respectively. When light projects on the pixel structure 20 from the first substrate 210 or from the second substrate 220, light is filtered by the color filter 280 and is absorbed by the color display medium 261. Moreover, the black display mediums 262a, 262b and 262c absorb the entire visible light and disallow light to pass through. Thus, the light quantity of light passing through the pixel structure 20 may be controlled by controlling the states of the black display mediums 262a, 262b and 262c.

To control the light quantity of light passing through the pixel structure 20, the similar manner described above is used. When the first pixel electrodes 251a, 251b and 251c and the common electrode are applied by a voltage therebetween or when the second pixel electrodes 252a, 252b and 252c and the common electrode are applied by a voltage therebetween, the move quantities, which all of the color display medium 261 and the black display mediums 262a, 262b and 262c are repelled by the light transmissive medium 270 to the positions of the electrodeless sections 201a, 201b and 201c respectively, may be controlled whereby the gray level of each of the sub pixel zones 200a, 200b and 200c may be controlled.

In some embodiments, the common electrode is applied with a low voltage, the first pixel electrodes 251a, 251b and 251c and the second pixel electrodes 252a, 252b and 252c are applied with a high voltage. In some embodiments, the common electrode is applied with a high voltage, the first pixel electrodes 251a, 251b and 251c and the second pixel electrodes 252a, 252b and 252c are applied with a low voltage. In some embodiments, the first pixel electrodes 251a, 251b and 251c are applied with a low voltage, the common electrode is applied with a middle voltage, and the second pixel electrodes 252a, 252b and 252c are applied with a high voltage. In some embodiments, the first pixel electrodes 251a, 251b and 251c are applied with a high voltage, the common electrode is applied with a middle voltage, and the second pixel electrodes 252a, 252b and 252c are applied with a low voltage.

FIG. 2B illustrates a sectional diagram of the pixel structure 20 of FIG. 2A displaying magenta. To display magenta via the pixel structure 20, the second pixel electrode 252b in the sub pixel zone 200b and the second pixel electrode 252c in the sub pixel zone 200c are applied with a voltage as the same as that of the common electrode, whereby the black display medium 262b in the sub pixel zone 200b and the black display medium 262c in the sub pixel zone 200c spread on the second film layer 232. Moreover, the first pixel electrode 251a and the second pixel electrode 252a in the sub pixel zone 200a are applied with a voltage different from that of the common electrode, whereby the black display medium 262a and the red droplet R move to and agglutinate at the position of the electrodeless section 201a. When light passes through the magenta section M of the color filter 280, the pixel structure 20 displays the magenta. Similarly, to display yellow or cyan via the pixel structure 20, the same manner described above is used to let light pass through the yellow section Y or the cyan section C in the color filter 280.

FIG. 2C illustrates a sectional diagram of the pixel structure 20 in FIG. 2A displaying red. To display red via the pixel structure 20, the second pixel electrode 252b in the sub pixel zone 200b and the second pixel electrode 252c in the sub pixel zone 200c are applied with a voltage as the same as that of the common electrode whereby the black display medium 262b in the sub pixel zone 200b and the black display medium 262c in the sub pixel zone 200c spread on the second film layer 232. The first pixel electrode 251a in the sub pixel zone 200a is applied with a voltage as the same as that of the common electrode whereby the red droplet R in the sub pixel zone 200a spreads on the first film layer 231. Moreover, the second pixel electrode 252a in the sub pixel zone 200a is applied with a voltage different from that of the common electrode whereby the black display medium 262a moves to and agglutinates at the position of the electrodeless section 201a. Thus, light passes through the magenta section M and the red droplet R of the color filter 280. The magenta section M allows light except green light to pass through, and the red droplet R allows red light to pass through, so that only red light passes through the magenta section M and the red droplet R. Herein, the pixel structure 20 displays red. Moreover, through adjusting the voltage supplied to the first pixel electrode 251a to adjust the spreading range of the red droplet R, which is from the position in FIG. 2B to the position in FIG. 2C, the pixel structure 20 may display the color between magenta and red.

The same manner described above is also used to let light pass through the yellow section Y and the green droplet G in the color filter 280 whereby the pixel substrate 20 may display green. Through adjusting the voltage supplied to the first pixel electrode 251b so as to adjust the spreading range of the green droplet G, the pixel structure 20 may display the color between yellow and green. Similarly, according to the above manner, the pixel structure 20 may display blue when light passes through the cyan section C and the blue droplet B in the color filter 280. When the voltage supplied to the first pixel electrode 251c is adjusted, the spreading range of the blue droplet B is changed. Herein, the pixel structure 20 may display the color between cyan and blue.

FIG. 2D illustrates a sectional diagram of the pixel structure 20 in FIG. 2A displaying the color between magenta and blue. When the second pixel electrode 252b in the sub pixel zone 200b and the first pixel electrode 251c in the sub pixel zone 200c are applied with a voltage as the same as that of the common electrode, the black display medium 262b in the sub pixel zone 200b spreads on the second film layer 232 and the blue droplet B in the sub pixel zone 200c spreads on the first film layer 231. When the first pixel electrode 251a and the second pixel electrode 252a in the sub pixel zone 200a are applied with a voltage different from that of the common electrode, the red droplet R and the black display medium 262a move to and agglutinate at the position of the electrodeless section 201a. Moreover, when the second pixel electrode 252c in the sub pixel zone 200c is applied with a voltage different from that of the common electrode, the black display medium 262c moves to and agglutinates at the position of the electrodeless section 201c.

When light passes through the magenta section M in the sub pixel zone 200a the sub pixel zone 200a displays magenta. When light passes through the cyan section C and the blue droplet B in the sub pixel zone 200c, the sub pixel zone 200c displays blue. Herein, the pixel structure 20 may display the color between magenta and blue, and the ratio of magenta and blue is changed according to the black display mediums 262a and 262c spreading on the second film layer 232.

According to the same manner described above, the sub pixel zone 200b displays yellow when light passes through the yellow section Y in the sub pixel zone 200b, and the sub pixel zone 200a displays red when light passes through the magenta section M and the red droplet R in the sub pixel zone 200a. Herein, the pixel structure 20 may display the color between yellow and red. The ratio of yellow and red is changed according to the black display mediums 262a and 262b spreading on the second film layer 232.

Similarly, the sub pixel zone 200c displays cyan when light passes through the cyan section C in the sub pixel zone 200c, and the sub pixel zone 200b displays green when light passes through the yellow section Y and the green droplet G in the sub pixel zone 200b. Herein, the pixel structure 20 displays the color between cyan and green. The ratio of cyan and green is changed according to the black display mediums 262b and 262c spreading on the second film layer 232.

FIG. 2E illustrates a comparison diagram of CIE xy chromaticity diagrams of the pixel structure in FIG. 2A and a conventional pixel structure. The pixel structure 20 is capable of displaying red r, yellow y, the color between red r and yellow y, green g, the color between yellow y and green g, cyan c, the color between green g and cyan c, blue b, the color between cyan c and blue b, magenta m, the color between blue b and magenta m, and the color between magenta m and red r. The color range of the pixel structure 20 is the color range surrounded with a solid line. In contrast to the pixel structure 20, the conventional structure with RGB color space displays only red r, green g, the color between red r and green g, blue b, the color between green g and blue b, the color between blue b and red r. The color range of conventional pixel structure is the color range surrounded with a dotted line. The color range of the pixel structure 20 is greater than that of the convention pixel structure. Thus, the pixel structure 20 is available to display more abundant colors with higher color saturation.

To let the pixel structure 20 display white, the first pixel electrodes 251a, 251b and 251c and the second pixel electrodes 252a, 252b and 252c are applied with a voltage different from that of the common electrode. Herein, the color display medium 261 moves to and agglutinates at the positions of the electrodeless sections 201a, 201b and 201c respectively, and the black display mediums 262a, 262b and 262c move to and agglutinate at the positions of the electrodeless sections 201a, 201b and 201c respectively. Light passes through the magenta section M, the yellow section Y and the cyan section C in the color filter 280. Moreover, the magenta section M absorbs only green light, the yellow section Y absorbs only blue light, and the cyan section C absorbs only red light. Thus, most of light is allowed to pass through the color filter 280. However, the convention pixel structure with RGB color space displays white formed by mixing light in a narrower spectrum, e.g. red light, green light and blue light. Accordingly, the brightness of white light formed by mixing light passing through the magenta section M, the yellow section Y and the cyan section C in the pixel structure 20 is brighter than that of the conventional pixel structure with RGB color space.

The ribs 241, 242 and 243 are made of polar material, so that the color display medium 261 and the black display mediums 262a, 262b and 262c respectively attach to the ribs 241, 242 and 243 difficulty. This is favorable that every color display medium 261 returns to the original position thereof on the first film layer 231, and that the black display mediums 262a, 262b and 262c return to their original positions on the second film layer 232 respectively. Thus, the response time spent on changing colors displayed by the pixel structure 20 may be reduced.

The electrodeless section 201a is between the first pixel electrode 251a and the rib 242. The electrodeless section 201b is between the first pixel electrode 251b and the rib 241. The electrodeless section 201c is between the first pixel electrode 251c and the rib 243. The color display medium 261 moves to the positions of the electrodeless sections 201a, 201b and 201c non-randomly. The black display mediums 262a, 262b and 262c move to the positions of the electrodeless sections 201a, 201b and 201c non-randomly. Through controlling the color display medium 261 and the black display mediums 262a, 262b and 262c, the color display medium 261 moves along a predetermined direction to filter predetermined light thereof out, and the black display mediums 262a, 262b and 262c move along a predetermined direction to block predetermined light thereof. Thus, the pixel structure 20 may not have light leakage or color error.

In some embodiments, the position of black display mediums 262a, 262b and 262c are exchanged with the position of the color display medium 261. In some embodiments, the color filter 280 is formed on the second substrate 220.

Accordingly, light is available to project on the pixel structure 20 from the first substrate 210 or from the second substrate 220, so that the pixel structure 20 can be applied in a smart window.

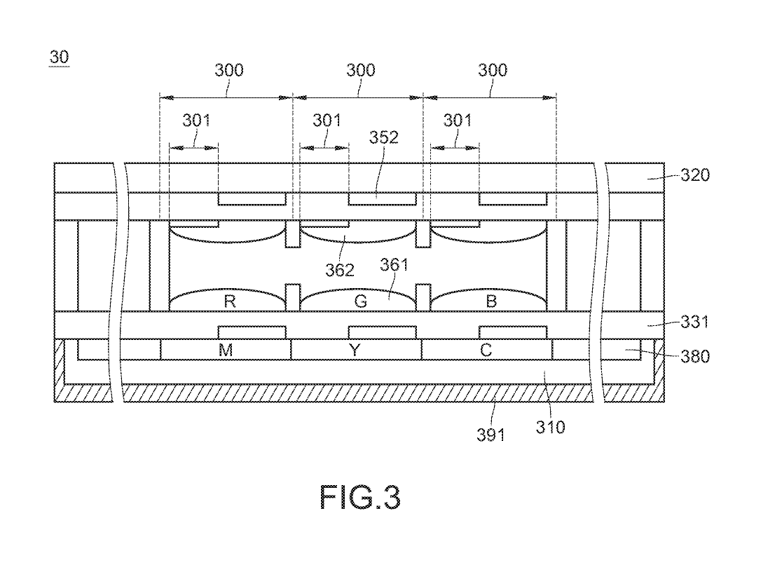

FIG. 3 illustrates a sectional diagram of the pixel structure 30 according to an embodiment of the disclosure. The pixel structure 30 is similar to the pixel structure 20 in FIG. 2A. The pixel structure 30 includes a plurality of sub pixel zones 300, a plurality of electrodeless sections 301 and a reflective backplate 391. The reflective backplate 391 is formed on the first substrate 310, so that the pixel structure 30 may be implemented in a reflective display device. Light projects on the pixel structure 30 from the second substrate 320. The color display medium 361 is formed on the first film layer 331. The black display medium 362 is formed on the second substrate 320 and is controlled by the second pixel electrodes 352. After passing through the color display medium 361 and the color filter 380, light is reflected by the reflective backplate 391. The reflected light passes through the color filter 380 and the color display medium 361, and is emitted out of the pixel structure 30 from the second substrate 320.

In some embodiments, the reflective backplate 391 is formed on the second substrate 320. Light projects on the pixel structure 30 from the first substrate 310. The reflective element is formed on the second film layer or between the second film layer and the second substrate 320.

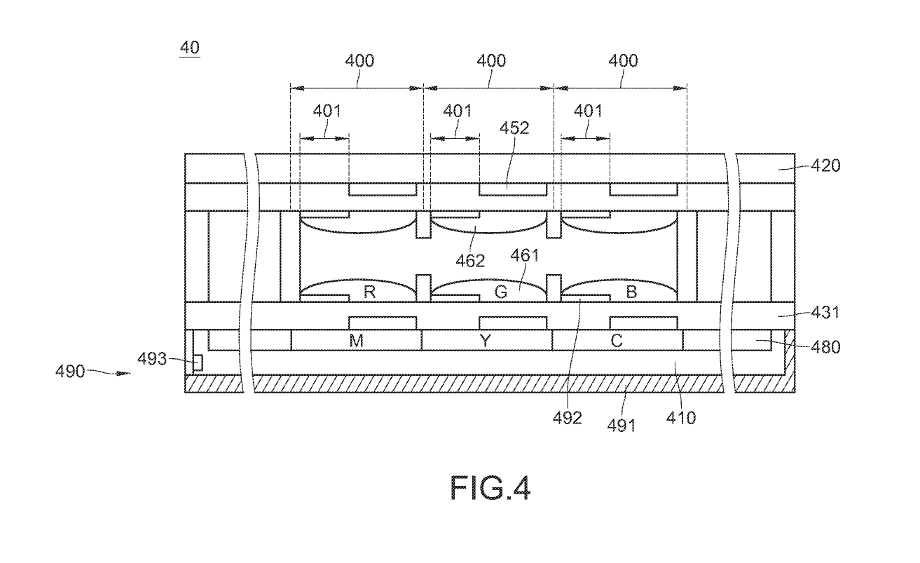

FIG. 4 illustrates a sectional diagram of the pixel structure 40 according to an embodiment of the disclosure. The pixel structure 40 is similar to the pixel structure 20 in FIG. 2A. The pixel structure 40 further includes a backlight module 490 formed on the first substrate 410. The backlight module 490 includes a reflective backplate 491 and a light source 493. The reflective backplate 491 is formed on the surface of the first substrate 410, and the light source 493 is formed on the lateral surface of the first substrate 410. The first substrate 410 performs as a light guiding element, and the pixel structure 40 can be applied in an emitting display device. Light projecting on the first substrate 410 from the light source 493 is reflected by the reflective backplate 491 to the color filter 480 and the color display medium 361, and then is emitted out of the pixel structure 40 from the second substrate 420.

Each of the sub pixel zones 400 further includes a reflective element 492. The reflective element 492 is formed in the electrodeless section 401 and on the first film layer 431. Light from the light source 493 is projected to the electrodeless section 401 partially, and then is reflected by the reflective backplate 491 to the electrodeless section 401. No matter if the second pixel electrode 452 is applied with a voltage or not, the black display medium 462 is always in the electrodeless section 401. The reflective element 492 reflects the light, which is projected on or is reflected to the electrodeless section 401, to the reflective backplate 491. Thus, the reflective backplate 491 reflects most light to the color filter 480 and the color display medium 461, and the reflected light is emitted out of the pixel structure 40 from the second substrate 420 so as to increase the brightness of the reflective display device. The reflective element 492 is formed on, for example, the first film layer 431.

In some embodiments, the reflective element 492 is formed between the first film layer 431 and first substrate 410. In some embodiments, the backlight module 490 is formed on the second substrate 420, and the reflective element 492 is formed on the second film layer or between the second film layer and the second substrate 420.

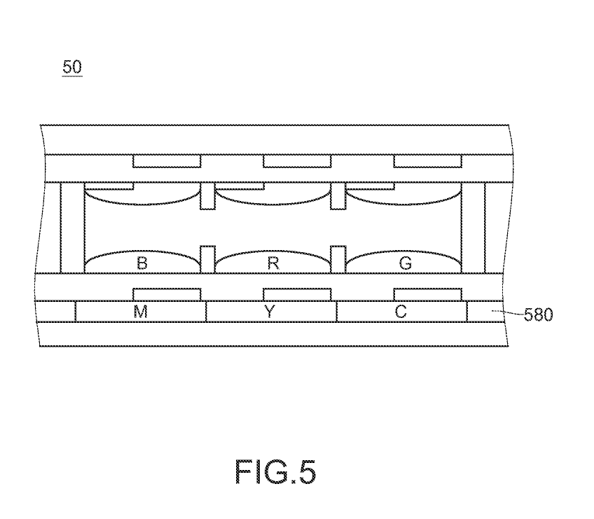

FIG. 5 illustrates a sectional diagram of a pixel structure according to an embodiment of the disclosure. The pixel structure 50 is similar to the pixel structure 20 in FIG. 2A. The differences between FIG. 5 and FIG. 2A are the magenta section M of the color filter 580 corresponding to the blue droplet B, the yellow section Y of the color filter 580 corresponding to the red droplet R, and the cyan section C of the color filter 580 corresponding to the green droplet G.

When light passes through the red droplet R and the yellow section Y, the pixel structure 50 displays red. Through controlling the red droplet R, the pixel structure 50 displays color between red and yellow. When light passes through the green droplet G and the cyan section C, the pixel structure 50 displays green. Through controlling the green droplet G, the pixel structure 50 displays color between green and cyan. When light passes through the blue droplet B and the magenta section M, the pixel structure 50 displays blue. Through controlling the blue droplet B, the pixel structure 50 displays the color between blue and magenta. When light passes through the red droplet R, the yellow section Y and the magenta section M, the pixel structure 50 displays the color between red and magenta. When light passes through the green droplet G, the cyan section C and the yellow section Y, the pixel structure 50 displays the color between green and yellow. When light passes through the blue droplet B, the magenta section M and the cyan section C, the pixel structure 50 displays the color between blue and cyan.

The disclosure may apply voltages to the pixel electrodes to form electrical fields, and then the light transmissive medium moves to the position of the film layer to repel the color display medium or the color display medium. Through repelling the color display medium or the color display medium in different ways, the pixel structure may display various colors so as to increase the color richness thereof. The pixel structure of the disclosure may also form the white with higher brightness.

The pixel structure of the disclosure may display more colors than the conventional display device with RGB color space. For example, the pixel structure of the disclosure may display red, the color between red and yellow, yellow, the color between yellow and green, green, the color between green and cyan, cyan, the color between cyan and blue, blue, the color between blue and magenta, magenta, and the color between magenta and red.

Moreover, the disclosure includes the electrodeless section between the pixel electrode and the rib, and the color display medium. The color display medium and the black display medium may move to the position of the electrodeless section. It is favorable to control the movements of the color display medium, the color display medium and the black display medium so as to avoid light leakage and color error and to increase the contrast ratio.

What is claimed is:

1. A pixel structure, comprising:
a first substrate and a second substrate opposite to the first substrate;
a plurality of ribs, formed between the first substrate and the second substrate, and dividing the pixel structure into a plurality of sub pixel zones;
a plurality of first pixel electrodes and a plurality of second pixel electrodes, the first pixel electrodes formed on the first substrate and respectively in the sub pixel zones, the second pixel electrodes formed on the second substrate and respectively in the sub pixel zones;
a color display medium, formed on the first substrate and among the ribs, the color display medium comprising a red droplet, a green droplet and a blue droplet, the red droplet, the green droplet and the blue droplet being formed in the sub pixel zones respectively;
a black display medium, formed on the second substrate and among the ribs;
a light transmissive medium, formed between the first substrate and the second substrate; and
a color filter, formed on the first substrate or on the second substrate and comprising a magenta section, a yellow section and a cyan section, spectrums, which light is allowed to pass through the color filter and the color display medium in one sub pixel zone, overlapping with each other partially.

2. The pixel structure according to claim 1, wherein each of the sub pixel zones further comprises an electrodeless section between the first pixel electrode and the rib and between the second pixel electrode and the rib.

3. The pixel structure according to claim 2, wherein each of the sub pixel zones further comprises a reflective element which is in the electrodeless section and formed on the first substrate.

4. The pixel structure according to claim 2, wherein each of the sub pixel zones further comprises a reflective element which is in the electrodeless section and formed on the second substrate.

5. The pixel structure according to claim 1, wherein the magenta section is disposed corresponding to the red droplet, the yellow section is disposed corresponding to the green droplet and the cyan section is disposed corresponding to the blue droplet.

6. The pixel structure according to claim 1, wherein the yellow section is disposed corresponding to the red droplet, the cyan section is disposed corresponding to the cyan droplet and the cyan section is disposed corresponding to the blue droplet.

7. The pixel structure according to claim 1, wherein the pixel structure further comprises a first film layer and a second film layer, the first film layer is disposed on the first substrate and in the sub pixel zones, the second film layer is disposed on the second substrate and corresponding to the first film layer.

8. The pixel structure according to claim 7, wherein the first pixel electrodes are disposed between the first substrate and the first film layer and the second pixel electrodes are disposed between the second substrate and the second film layer.

9. The pixel structure according to claim 7, wherein the first film layer and the second film layer are made of non-polar material.

10. The pixel structure according to claim 1, wherein the black display medium and the color display medium are made of non-polar material, and the light transmissive medium and the ribs are made of polar material.

11. A pixel structure, comprising:
a first substrate and a second substrate opposite to the first substrate;
a plurality of ribs, disposed between the first substrate and the second substrate, and dividing the pixel structure into a plurality of sub pixel zones;
a plurality of first pixel electrodes, disposed on the first substrate and respectively in the sub pixel zones, each of the sub pixel zones comprising an electrodeless section between the first pixel electrode and the rib;
a first color display medium, disposed on the first substrate and among the ribs; and
a light transmissive medium, disposed between the first substrate and the second substrate.

12. The pixel structure according to claim 11, wherein each of the sub pixel zones further comprises a reflective element in the electrodeless section and disposed on the first substrate.

13. The pixel structure according to claim 11, wherein the pixel structure further comprises a first film layer made of non-polar material and disposed on the first substrate and in the sub pixel zones, the first film layer is opposite to the second substrate, the first pixel electrodes are disposed between the first substrate and the first film layer, and the first color display medium is disposed on the first film layer.

14. The pixel structure according to claim 11, wherein the pixel structure further comprising:
a plurality of second pixel electrodes, disposed on the second substrate and respectively in the sub pixel zones;
a second color display medium, disposed on the second substrate and between the ribs, the first color display medium comprising a red droplet, a green droplet and a blue droplet which are respectively disposed in the sub pixel zones, and the second color display medium comprising a black oil; and
a color filter, disposed on the first substrate or on the second substrate, comprising a magenta section, a yellow section and a cyan section, and spectrums, which light is allowed to pass through the color filter and the first color display medium in one sub pixel zone, overlapping each other partially.

15. The pixel structure according to claim 14, wherein a position of the magenta section corresponds to a position of the red droplet, a position of the yellow section corresponds to a position of the green droplet, and a position of the cyan section corresponds to a position of the blue droplet.

16. The pixel structure according to claim 14, wherein a position of the yellow section corresponds to a position of the red droplet, a position of the cyan section corresponds to a position of the green droplet, and a position of the magenta section corresponds to a position of the blue droplet.

17. The pixel structure according to claim 14, wherein the electrodeless section is between the second pixel electrode and the rib.

18. The pixel structure according to claim 17, wherein the color filter is disposed on the second substrate, the second pixel electrodes are disposed between the color filter and the second substrate.

19. The pixel structure according to claim 18, wherein the pixel structure further comprises a first film layer made of non-polar material and a second film layer, the first film layer is disposed on the first substrate and in the sub pixel zones, the first film layer is opposite to the second substrate, the second film layer is disposed between the second substrate and the light transmissive medium, the ribs are disposed on the second film layer and are between the first film layer and the second film layer.

20. The pixel structure according to claim 11, wherein the pixel structure further comprises a common electrode disposed on the light transmissive medium.
